(19) United States
(12) Patent Application Publication
(10) Pub. No.: US 2009/0159384 A1
(43) Pub. Date: Jun. 25, 2009

(54) ENERGY ABSORBER AND SYSTEM

(75) Inventors: Ravi Kiran Chitteti, Nellore Dist. (IN); Norasimhon Krishnamoorthy, Bangalore (IN); Takaaki Nemoto, Shizuoka (JP)

Correspondence Address: SABIC - 08CT;SABIC Innovative Plastics - IP Legal, ONE PLASTICS AVENUE, PITTSFIELD, MA, 01201-3697, US

(73) Assignee: SABIC Innovative Plastics IP BV, Pittsfield, MA (US)

(21) Appl. No.: 11/960,015

(22) Filed: Dec. 19, 2007

(51) Int. Cl. F16F 7/12

(52) U.S. Cl. 188/377; 296/187.03

(57) ABSTRACT

Various embodiments of an energy absorber are included. In one embodiment, the energy observer includes a base, a top spaced apart from the base and a plurality of legs that extend from the top to the base and that are spatially arranged relative to one another with window openings interposed between them. In another embodiment, the interface of each of the plurality of legs that contact the top are vertically offset from the interface of each of the legs at the base. The present invention also provides for an energy absorber system that includes at least one energy absorber comprising at least one mating connector component that connects to another mating component of another energy absorber.

### FIELD OF THE INVENTION

The present invention relates to an energy absorber and the method of using the energy absorber. More specifically, the present invention relates to an energy absorber for absorption of impact and the use of the energy absorber in the interior of vehicles.

### BACKGROUND OF THE INVENTION

The use of structures for absorbing energy is known. In vehicles, for example motor vehicles, one or more energy absorbers can be located adjacent to an interior component such as a pillar, side rail, or an instrument panel, for example, which would be brought into contact with an occupant's body in the event of a collision of the vehicle.

When a vehicle such as a passenger car is involved in a crash, airbags are deployed to protect the occupants. The side/curtain-type airbags that extend along the length of the passenger cabin are designed to protect the occupants from making contact with side interior components, such as pillars and window openings, etc. However, there is little protection to occupants when they make contact with the roof just above the side/curtain airbag. Specifically, roof energy absorbers located in this region, between the exterior roof panel and the roof liner, help protect the occupants and helps meet FMVSS 201 regulations governing head impacts.

The current energy absorber structures include foamed plastic structures, plastic ribbed structures such as a polypropylene honeycomb, deformable hollow bodies, and deformable metallic structures such as aluminum pipe. Foamed structures can have various densities and are capable of absorbing energy when compressed either by destruction of their open cells or by compression of their closed cells. Plastic ribbed structures are capable of absorbing energy by deformation or collapse of the walls of the defined structures when a force impacts against them. These current structures are expensive and/or do not meet the performance requirements.

### SUMMARY OF THE INVENTION

The present invention provides for various embodiments of an energy absorber that act as a crushing member and to absorb energy in a controlled manner. In one embodiment the energy absorber includes a base, a top, and a plurality of legs, each of which extends from the top to the base and which are spatially arranged with window openings interposed between the legs. During impact the legs of the energy absorber can bend outward or inward to control the reaction force during crushing in order to minimize injury to an occupant in the event of a collision, for example. In another embodiment each of the plurality of legs connect to the top of the energy absorbers along a first vertical plane and connect to the base of the along a second vertical plane which is different than the first vertical plane. That is, the attachment of the plurality of the legs to the top is vertically offset by the attachment of the legs to the base. Upon impact the plurality of legs fold inwardly or outwardly from the energy absorber. The design of the legs, their geometries and their positioning relative to the top and the base allow the energy absorber to absorb the reaction force in a controlled manner while also reducing stack height of the energy absorber upon impact.

The present invention also provides for an energy absorber system including a plurality of energy absorbers connected together. In one embodiment the energy absorber includes a female connector and a male connector. The female connector of a first energy absorber mates with a male connector of a second energy absorber along at least one side of the respective energy absorbers. In one embodiment the male and female connector portions are located along a portion of the base of the respective energy absorbers. Several energy absorbers can connect to one another in one or more directions to form an energy absorber system, such as for example, a matrix of energy absorbers.

### BRIEF DESCRIPTION OF THE DRAWINGS

The various embodiments of the present invention can be understood by the following drawings and figures. The components are not necessarily to scale.

FIG. 1 is a top view schematic diagram of a vehicle showing an energy absorbing system located in the roof of the passenger cabin;

FIG. 2 is a cross-sectional view of the roof of the vehicle taken along lines 2-2 of FIG. 1 showing the energy absorber located between the roof and the roof liner of the passenger cabin, according to an embodiment of the present invention;

FIG. 3 is a schematic perspective view of an energy absorber used in the energy absorbing system of FIG. 1, according to an embodiment of the present invention;

FIG. 3A is a side plan view of the energy absorber of FIG. 3, according to an embodiment of the present invention;

FIG. 3B is a schematic cross-section of the energy absorber of FIG. 3 and FIG. 3A showing the energy absorber in a partially collapsed position upon impact, according to an embodiment of the present invention;

FIG. 4A is a schematic cross-section of an alternative energy absorber including legs which have a radius portion proximate the base, according to an embodiment of the present invention;

FIG. 4B is a schematic cross-section of the energy absorber of FIG. 4A showing the energy absorber in a partially collapsed position upon impact, according to an embodiment of the present invention;

FIG. 5 is a cross-sectional view taken along lines 5-5 of the energy absorber FIG. 3A, according to an embodiment of the present invention;

FIG. 6 is the cross-sectional view taken along lines 6-6 of the energy absorber FIG. 3A, according to an embodiment of the present invention;

FIG. 7 is a schematic perspective view of an alternative energy absorber, according to another embodiment of the present invention;

FIG. 8 is a side plan view of the second energy absorber of FIG. 7, according to an embodiment of the present invention;

FIG. 9 is a cross-sectional view the energy absorber taken along lines 9-9 of the energy absorber of FIG. 8, according to an embodiment of the present invention;

FIG. 10 is a cross-sectional view taken along lines 10-10 of FIG. 8, according to an embodiment of the present invention;

FIG. 11 is a cross-sectional view taken along lines 11-11 of FIG. 8, according to an embodiment of the present invention;

FIG. 12 is a perspective schematic view of an energy absorber having a connecting portion which is located at an end portion of the base of the energy absorber, according to an embodiment of the present invention;

FIG. 13 is a schematic perspective view of an energy absorbing system which includes a plurality of energy absorbers of FIG. 12, according to an embodiment of the present invention;

FIG. 14 is a schematic perspective view of an energy absorber having female and male connectors which extend along end portions of the base of the energy absorber, according to an embodiment of the present invention;

FIG. 15 is a perspective view of an energy absorbing system which includes a plurality of energy absorbers of FIG. 14 connected together, according to another embodiment of the present invention;

FIG. 16 is a perspective schematic view showing end portions of two energy absorbers which fit together in a tongue and groove configuration, according to an embodiment of the present invention;

FIG. 17 is a perspective view of an energy absorber having a protrusion and a slot on opposite end portions of the energy absorber, according to an embodiment of the present invention;

FIG. 18 is a cross-sectional view taken along lines 18-18 of FIG. 17, showing the pin and hole fit connection of the energy absorber, according to an embodiment of the present invention;

FIG. 19 is a perspective view of an energy absorber showing a groove and latch located on opposite end portions of the energy absorber, according to an embodiment of the present invention;

FIG. 20 is a perspective view of an energy absorber having a raised protrusion at one end portion and at least one opening on a second end portion of the energy absorber, according to an embodiment of the present invention;

FIG. 21 is a cross-sectional view taken along lines 20-20 of FIG. 20 showing the slot in opening fit of the end portions of the energy absorber, according to an embodiment of the present invention;

FIG. 22 is a perspective view of an energy absorber having a slot and latch connectors, according to an embodiment of the present invention; and

FIG. 23 is a top view of the end portion of the energy absorber of FIG. 22 showing the slot and latch fit connection, according to an embodiment of the present invention.

### DETAILED DESCRIPTION OF THE INVENTION

The present invention is more particularly described in the following description and examples that are intended to be illustrative only since numerous modifications and variations therein will be apparent to those skilled in the art. As used in the specification and in the claims, the singular form “a,” “an,” and “the” may include plural referents unless the context clearly dictates otherwise. Also, as used in the specification and in the claims, the term “comprising” may include the embodiments “consisting of” and “consisting essentially of.” Furthermore, all ranges disclosed herein are inclusive of the endpoints and are independently combinable.

As used herein, approximating language may be applied to modify any quantitative representation that may vary without resulting in a change in the basic function to which it is related. Accordingly, a value modified by a term or terms, such as “about” and “substantially,” may not to be limited to the precise value specified, in some cases. In at least some instances, the approximating language may correspond to the precision of an instrument for measuring the value.

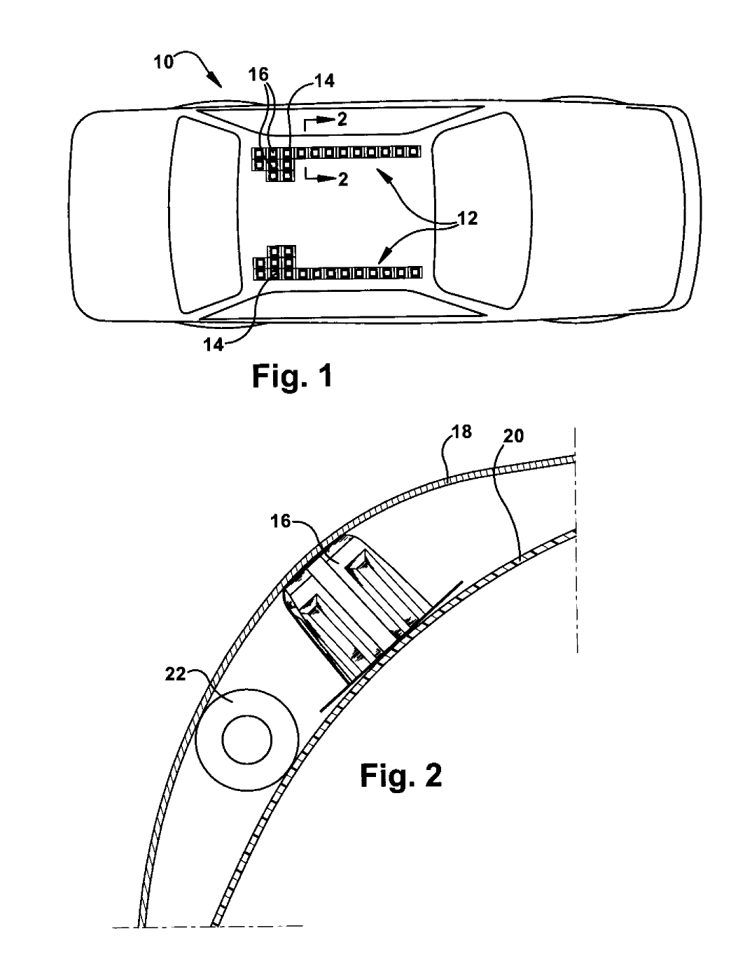

FIG. 1 is a schematic top view of a vehicle, for example, an automobile 10, showing the energy absorbing system 14 along the side portions 12 of the roof of the passenger compartment, according to an embodiment of the present invention. It should be understood that although the embodiments of the present invention described herein pertains to a vehicle 10, it is contemplated that the energy absorber 16 and energy absorbing system 14 can be utilized in a variety of applications requiring shock absorption.

FIG. 2 is a cross-section view taken along the lines 2-2 of FIG. 1, according to an embodiment of the present invention. A close-up view of the energy absorber system 14 is shown in FIG. 2 in which the energy absorber 16 disposed between the roof exterior 18 and the roof liner 20 of the automobile compartment of the vehicle of FIG. 1. The energy absorber 16 affords protection to occupants in locations where the occupant makes contact with the roof liner 20 of the automobile in areas where the occupant is unprotected by the airbag for example, in areas adjacent to the side curtains or air bag 22.

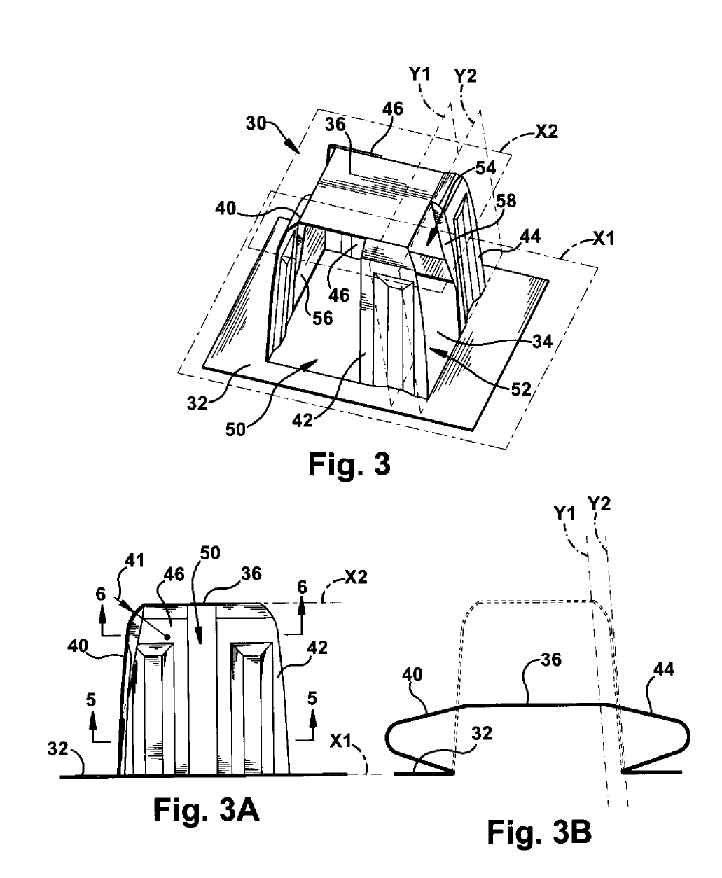

FIG. 3 is a perspective view of energy absorber 30 according to an embodiment of the present invention. Energy absorber 30 includes a base 32 situated along a horizontal plane X1 and a top 36 spaced a distance from the base which resides in a horizontal plane X2. The top 36 can optionally include an opening (not shown) and the base optionally includes an opening for example, opening 34. Energy absorber 30 includes a plurality of legs 40, 42, 44 and 46 that extend from the top of 36 to the base 32 and are spatially arranged with a plurality of window openings, for example, window openings 50, 52, 54 and 56 interposed between them. It should be understood that here and elsewhere in the written description, the term “plurality” means two or more. The window openings are framed by the edges of the legs, base 32 and top 36. In one embodiment, the window openings, for example, window openings 50, 52, 54 and 56 extend from the top 36 to the base 32, however, the window openings between the legs may extend along only a portion of the legs.

The embodiment of FIG. 3 shows that each of the plurality of legs 40, 42, 44 and 46 connect to the top 36 of the energy absorber along a first vertical plane Y1 and connect to the base 32 of the energy absorber along a second vertical plane Y2 which is different than the first vertical plane. That is, the interface of each of the plurality of the legs at top 36 is vertically offset from the interface of each of the legs at the base 32. The area of top 36 is less than the area of opening 34 of base 32, and therefore, each of the legs extend between the two vertical planes. For example, leg 44 extends between planes Y1 and Y2.

FIG. 3A shows that the top portion of the legs, for example top portion of leg 40, has a radius 41 such that the leg extends inward to connect to the top 36. Upon impact, the force exerted on the top and/or base of the energy absorber will cause the legs to buckle outwardly away from the base opening as the energy absorber 30 collapses. The legs may not include a radius and may instead have two leg portions which are oriented at an angle relative to one another so that each leg spans from an inner vertical plane Y1 to an outer vertical plane Y2 between the contact points at the top and the base, in order to facilitate buckling of the legs in an outward direction.

Therefore, energy absorber 30, in accordance with embodiments of the present invention, includes four sides defined by a rectangular top 36 and rectangular base 32, where each of the sides includes one leg. The width of the legs along each side can vary. The perspective view of FIG. 3 in conjunction with the plan view of FIG. 3A of energy absorber shows that the width of rear leg 46 is narrower than the front window opening 50 opposite therefrom and narrower than adjacent window 54 (FIG. 3). Therefore, plan view of FIG. 3A shows that an opening passes through the entire energy absorber on any of the sides. It should be understood, however, that the width and height dimensions of the legs can vary as well as the width and height dimensions of the window opening depending on the particular application, reaction force requirements and the desired resistance of the energy absorber.

FIG. 3B is a schematic cross-section of the energy absorber of FIG. 3 and FIG. 3A showing the energy absorber in a partially collapsed position upon impact, according to an embodiment of the present invention. The legs of the energy absorber are collapsed outwardly toward the exterior of the energy absorber. If impact force is great enough the top 36 of crushed energy absorber becomes substantially coplanar with base 32. Depending upon the size of base opening 34 (FIG. 3) a spherical impactor, for example the head of an occupant in a vehicle, may clear the base and directly contact top 36. The stack height of the energy absorber 30 in the tallest portion of a substantially crushed energy absorber is the sum of the thickness of base 32 and twice the thickness of one of the legs, such as leg 40 or 44.

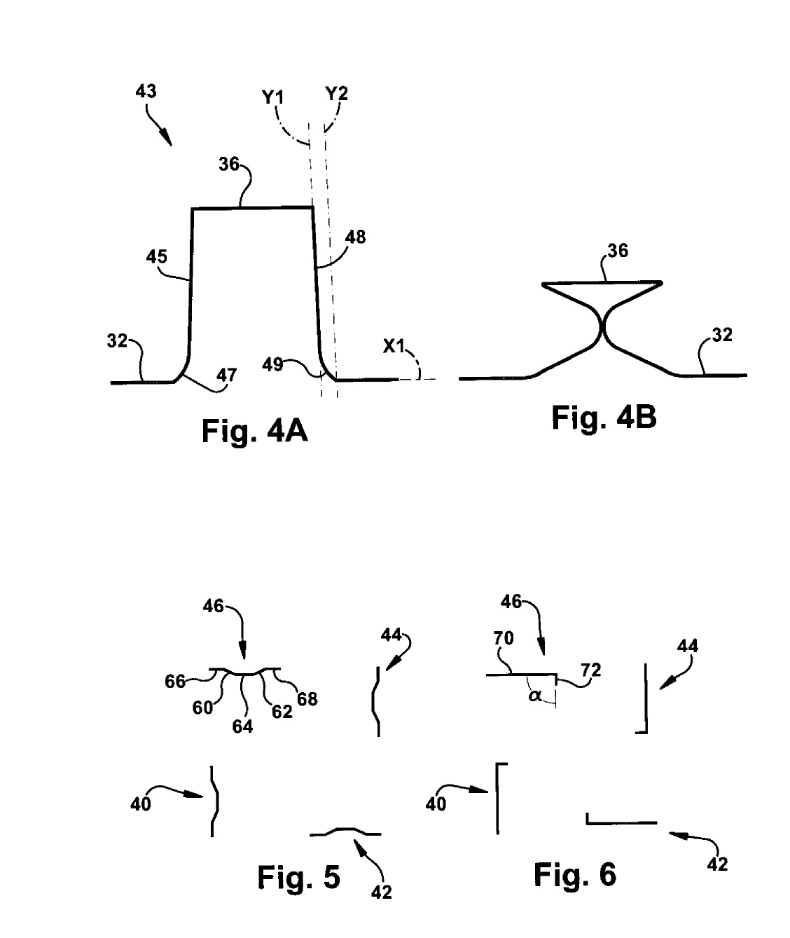

FIG. 4A is a schematic cross-sectional illustration of an alternative energy absorber 43 having base 32, top 36, and legs 45 and 48. Energy absorber 43 is similar to energy absorber 30 however, the bottom portion of legs 45 and 48 have radius portions 47 and 49, respectively, which extend outward to connect to base 32. The upper portion of leg 48 connects to top 36 along inner, vertical plane Y1 and the lower portion of leg 48 connects to base 32 along outer, vertical plane Y2. The outwardly flared legs will be urged to buckle inward toward the interior of the energy absorber upon impact to the energy absorber. FIG. 4B shows a schematic representation of the cross-section of the energy absorber of FIG. 4A in a partially collapsed position upon impact. Depending upon the impact force, the stack height of the energy absorber can be as short as the summation of the thickness of top 36 and two times the wall thickness of leg 48 when it is collapsed and folded upon itself, for example.

FIGS. 5 and 6 illustrate additional design features of the energy absorber to provide crush resistance and/or to absorb the energy in a controlled manner. The energy absorbers, for example energy absorbers 30 and 43 may be tuned to absorb varying amounts of impact force. For example, the energy absorber can include profile shapes, ribs, and buttresses that allow the energy absorber to meet higher reaction force requirements. FIG. 5 shows a cross-sectional view taken along lines 5-5 of the energy absorber of FIG. 3A. A cross-sectional view shows the profile view of the legs, for example, legs 40, 42, 44, 46 that are inwardly concave and project towards the interior of the energy absorber 30. The concave geometry of the legs is formed by a plurality of leg segments. For example leg 46 at cross-section 5-5 is formed by leg segments 60, 62, 64, 66, and 68. In another example, the concave leg 46 may be curved or arcuate. Alternatively, each of the legs can have a convex profile in which the leg projects towards the exterior of the energy absorber. In another embodiment each of the legs can be substantially planar.

FIG. 6 is a cross-sectional view taken along lines 6-6 of energy absorber 30 in FIG. 3A. A horizontal cross-section of legs 40, 42, 44 and 46 proximate top 36 of energy absorber shows each of the legs include two leg segments oriented at an angle relative to one another. For example, leg 46 includes leg segment 70 and 72 separated by an angle alpha, α. The angle α can vary and is less than about 180 degrees, in another embodiment, the angle can range from about 45 to about 135 degrees, and in another embodiment, the angle is substantially 90 degrees. In another embodiment leg segments 72 can extend toward the exterior of the energy absorber rather than toward the interior of the energy absorber as shown. The relative sizes of leg segments 70 and 72 can also vary in length and thickness.

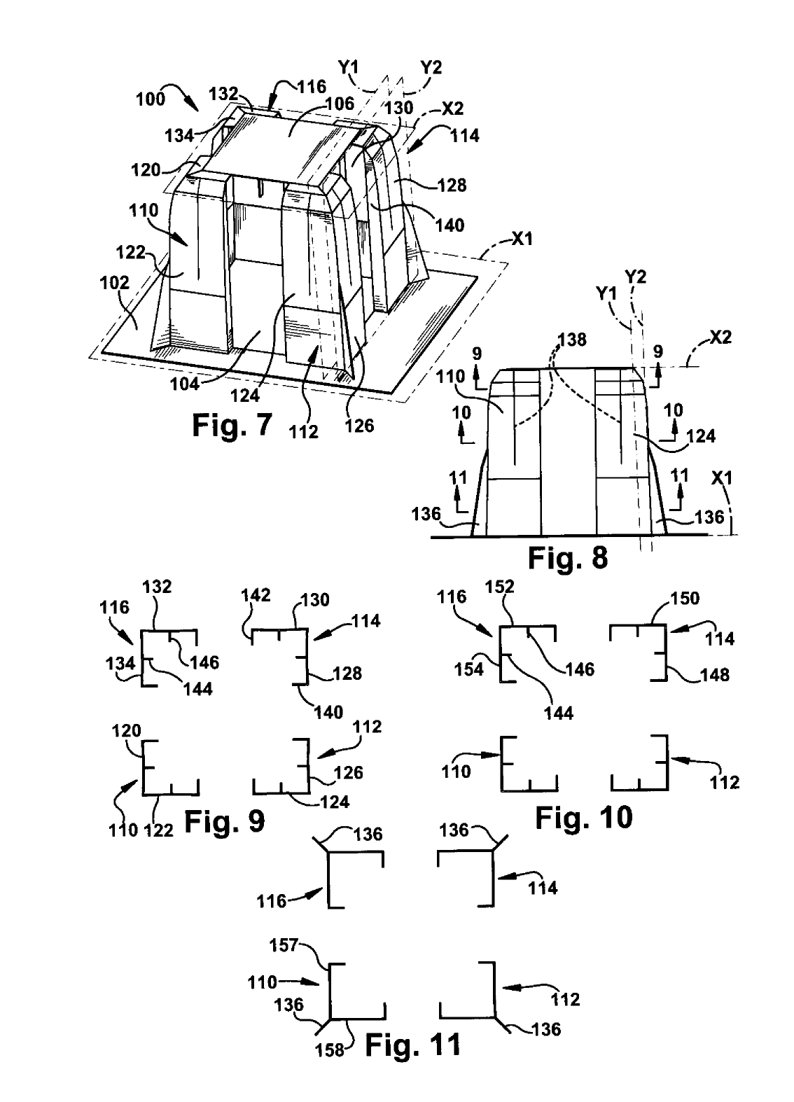

The design of the legs of the energy absorber, according to various embodiments herein, can vary to offer greater crush resistance where reaction force requirements are different at different locations. For example, vehicle 10 shown in FIG. 1 may beneficially include an energy absorber system made up of energy absorbers of varying reaction force requirements and sizes depending upon the location of the energy absorber along the roof of the passenger compartment. FIGS. 7 and 8 show a perspective view and a side plan view, respectively, of energy absorber 100 according to another embodiment of the present invention. FIG. 7 shows that energy absorber 100 includes a base 102 which resides in a horizontal plane X1 and optionally includes opening 104, and top 106 spaced a distance from the base which resides in a horizontal plane X2, and a plurality of legs 110, 112, 114, 116 which extend from top 106 to base 102 and are spatially arranged with window openings 130 interposed therebetween. In one embodiment, each of the legs has two leg segments oriented at an angle relative to one another, for example, leg segments 120, 122 of leg 110, leg segments 124, 126 of leg 112, 128, 130 of leg 114, and leg 132, 134 of leg 116. Also, each of the plurality of sides of the energy absorber 100 includes a leg segment of a first leg and a second leg segment of a second leg. Window openings 130 disposed between the legs extend from the top 106 to the base 102, however, the window openings between the legs may extend along only a portion of the legs. FIG. 8 shows that the legs are arranged symmetrically such that the window opening aligns with one another from the opposite walls of the energy absorber.

In the example embodiment shown, each of the plurality of legs 110, 112, 114, 116 connect to the top 106 of the energy absorber 100 along a first vertical plane Y1 and connect to the base 102 of the energy absorber along a second vertical plane Y2 which is different than the first vertical plane. Each of the legs can include a first leg segment and a second leg segment which are oriented at an angle relative to one another such that the interface of at least one leg which contacts the top is vertically offset from the interface of that same leg at the base. The intersection of the legs segments aligns with the corners of the top 106 and also aligns with corners of the base 102. That is, top 106 is a polygon including at least two sidewalls that meet at a corner to form a least a first angle, and at least one of the plurality of legs has two leg segments meet at a corner to form a second angle which is substantially equal to the first angle of the top. In addition the base 102 includes internal sidewalls which define the base opening 104, the internal sidewalls meet to form at least one corner to form a third angle which is substantially equal to the second angle between the corner of the legs. It should be understood, however, that the width and height dimensions of the legs can vary as well as the width and height dimensions of the window openings depending on the particular application, reaction force requirements and the desired resistance of the energy absorber.

In additional embodiments of the present invention, the energy absorbers herein can include additional reinforcements to tune or alter the rigidity. For example, FIGS. 7 and 8 show that each of the legs can include angled buttress 136 which reinforce the legs. The buttress 136 can extends from any point along the leg, for example legs 110, 112, 114 of the leg to the base 102. In addition, each of the legs segments can optionally includes a rib, for example internal rib 138 which extends vertically along at least a portion of the length of legs 110, 112.

FIG. 9 is a cross-sectional view the energy absorber taken along lines 9-9 of the energy absorber of FIG. 8, showing a profile view of legs 110, 112, 114, and 116 showing leg segments 120 and 122 of leg 110, leg segments 124, 126 of leg 112, leg segments 128, 130 of leg 114 and leg segments 132, 134 of leg 116. As described above, the leg segments are angled relative to one another, for example at an angle which can range from about 45 degrees to about 135 degrees, and in another example, about 90 degrees. Each of the leg segments of FIG. 9 are shown as concave and bowed toward the interior of the energy absorber, however, they can be convex or substantially planar. The legs of energy absorber 114, for example, can optionally include leg extensions as depicted by leg extensions 140 and 142 that extend from the edges of leg segments 128, 130. The leg extensions are directed toward the interior of the energy absorber and are oriented at an angle that ranges from about 45 degrees to about 135 degrees, and in another example, about 90 degrees relative to the connecting leg segment. In addition, one or more of the legs can also optionally include ribs. For example, leg 116 includes ribs 144, 146 can be directed toward the interior or the exterior of the energy absorber 100.

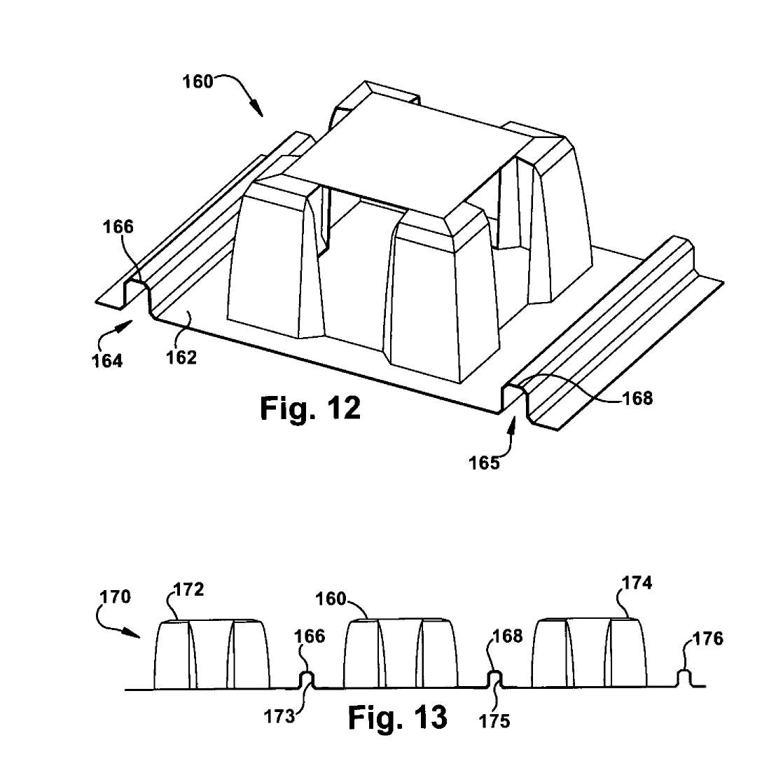

FIG. 10 is a cross-sectional view taken along lines 10-10 of FIG. 8, according to an embodiment of the present invention. The cross-section of the legs show that the leg segments, for example leg segments 148, 150 of leg 114 and leg segments 152 and 154 of leg 116 are substantially planar and therefore different from the concave sidewalls shown in FIG. 9. FIG. 11 is a cross-sectional view taken along lines 11-11 of FIG. 8 and show buttresses 136 which extend from legs 110, 112, 114, and 116 near the base. The external extensions can be oriented at an angle relative to a leg segment. For example buttress 136 is oriented at an angle that ranges from about 35 degrees to about 145 degrees relative to each leg segment 157 and 158. Therefore, the cross-section of the legs, as shown by the example profiles in FIGS. 9, 10 and 11, can vary from the top 36 to the base 32 of the energy absorber, having at least two cross-sections that are different.

As mentioned above, several features can be incorporated in to the legs of the energy absorber to increase the rigidity for greater impact resistance requirements. The energy absorbers shown by the various embodiments in accordance with the present invention herein include a plurality of sides defined by the geometry of the top and the base. The shape of the energy absorbers 30, 43 and 100 described above are generally rectangular, although the energy absorbers having polygonal shapes and a plurality of sides are also within the scope of the present invention. For example, the energy absorber may have a top and a base that are polygons having three, five or six sides, etc., and the energy absorber can be a polygonal structures with various numbers of legs. The legs may be equidistant from one another but can also vary in distance relative to one another as well as vary in height and width as described. The energy absorber herein can be tuned by the geometry of the top, base and legs, as well as the reinforcing features described above, to absorb energy in a controlled manner based on the impact resistance requirements of a given application.

FIGS. 12 through 23 pertain to various embodiments of energy absorbers including one of several different types of mating connector members. The mating connector member allows for assembly of the individual energy absorbers to produce an energy absorber system, for example energy absorbers 16 (FIG. 1) which connect to form energy absorbing system 14 (FIG. 1). These energy absorbers can connect along multiple directions depending upon the shape and number of sides of the energy absorber. An example of an energy absorber system having a two-directional matrix is shown in the roof of vehicle FIG. 1. The connector members of the various embodiments described below include at least one mating connector member along the base of the energy absorber, but typically, each energy absorber includes at least two different mating connector members of a connector type. Therefore, when the energy absorbers are assembled, a mating connector member along one side of the energy absorber connects to its respective mating connector member along a second side of the base. Therefore, each energy absorber includes two mating “halves” of the connector, which are different but join to form a connector type.

In the various embodiments of energy absorber systems and energy absorber connectors described below, the base of two or more energy absorbers include at least two mating connector member joined together such that the base is substantially free of protrusions upon impact. That is, the base of the energy absorber system contains no pointed loads present that might injure the occupant upon deformation of the energy absorber. For example, in one embodiment, the connector of the energy absorber system can be deformable such that it will absorb energy at the end of the crash when the energy absorber has been crushed. In another example embodiment, the connectors include connector portions that, once connected, have a substantially planar surface such that there are no protrusions or pointed loads.

FIG. 12 shows an energy absorber 160 which is similar to energy absorber 100 (FIG. 7) having a base portion which includes two mating connector member 164, 165 of a snap connector, each of which is located on opposite sides of the base 162. The mating connector members are substantially similar in shape each having a channel 166, 168. The channels 166, 168 are flexible and the thickness of the channels or snaps are adjusted to ensure that the snap connector formed by mating connector members 164, 165 crushes when the energy absorber is impacted, to absorb additional energy near the end of the crash.

FIG. 13 shows an energy absorber system 170 including a plurality of energy absorber units 160, 172, 174 (FIG. 12) and the manner in which they connect to one another. The snap 166 of mating connector member 164 is mated to mating connector members 173 of energy absorbers 172, and snap 168 of mating connector member 165 is mated to mating connector 175, of energy absorber 174. The flexibility of the connecting portion and the substantially similar shape allow for a secure fit between the connector portions. The height and length of each mating connector member and/or snap can be adjusted based on the absorption and impact requirements for the particular application. As shown in FIG. 12 the length of the channels 166, 168 extend the entire length of the base 162. The energy absorber as shown in FIG. 12 has connector portions 164, 165 on two opposite sides of the base 162, however it is also possible that the energy absorber includes a mating connector member on adjacent sides and on every side of the base 162.

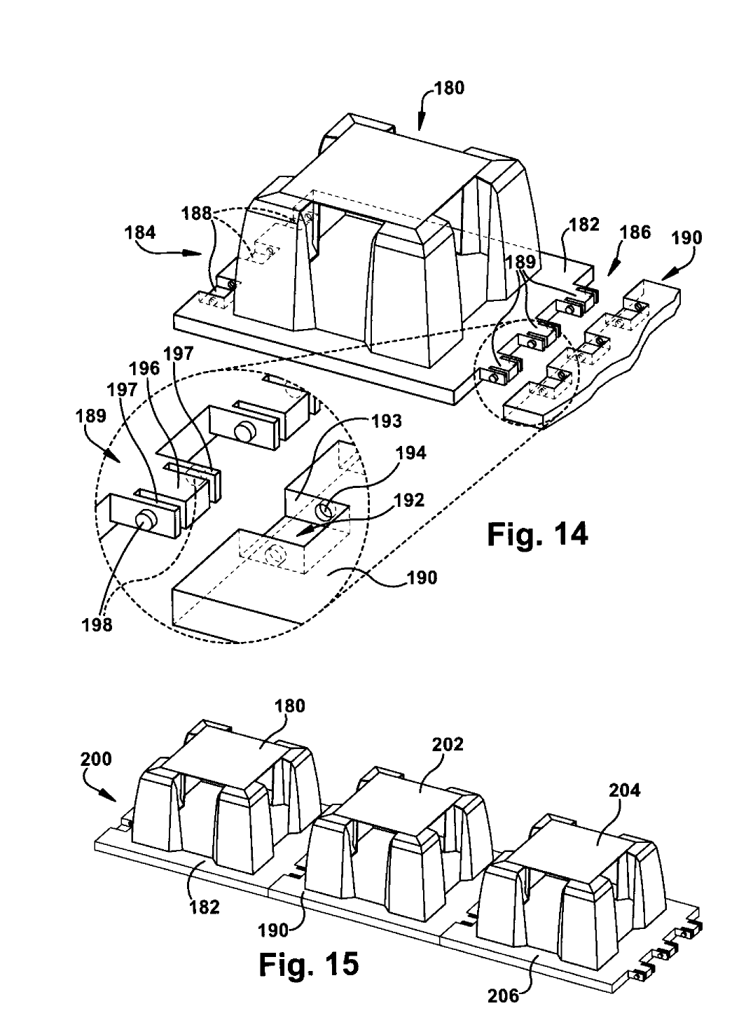

FIG. 14 shows the energy absorber 180 that is substantially similar to energy absorber 100 (FIG. 7) and further includes mating connector members 184, 186, of a flex finger interlock connector, according to another embodiment of the present invention. The base 182 of the energy absorber 180 includes a plurality of tooth-like protrusions 189 which include a central body 196 and two flex fingers 197 which extend from the central body 196. When energy absorber 180 is joined to a like energy absorber 190 the enlarged view shows that the protrusions 189 along one side 186 of the energy absorber 180 fit into the female recesses 192 along an edge of the mating energy absorber 190. The tooth-like protrusions 189 insert into recesses 192 located on the opposite side of the base of a similar energy absorber 190. As the flex fingers 197 are inwardly biased during connection, the flex-finger protrusions, for example button protrusions 198 spring into recesses 194 to provide an interference fit which helps prevent the tooth-like protrusions from pulling away from recess 192.

FIG. 15 shows energy absorber system 200 including a plurality of energy absorbers 180, 202, 204 connected to one another. These energy absorbers are shown connected in a linear direction but can also connect and two directional arrays (not shown). For example, the energy absorber of FIG. 15 can include protrusions along two of the four portions of the base 182 and may also include recesses along the two sides of the base such that the energy absorbers are connected along two or more sides. When connected together the bases of energy absorbers 182, 190 and 206 are substantially planar.

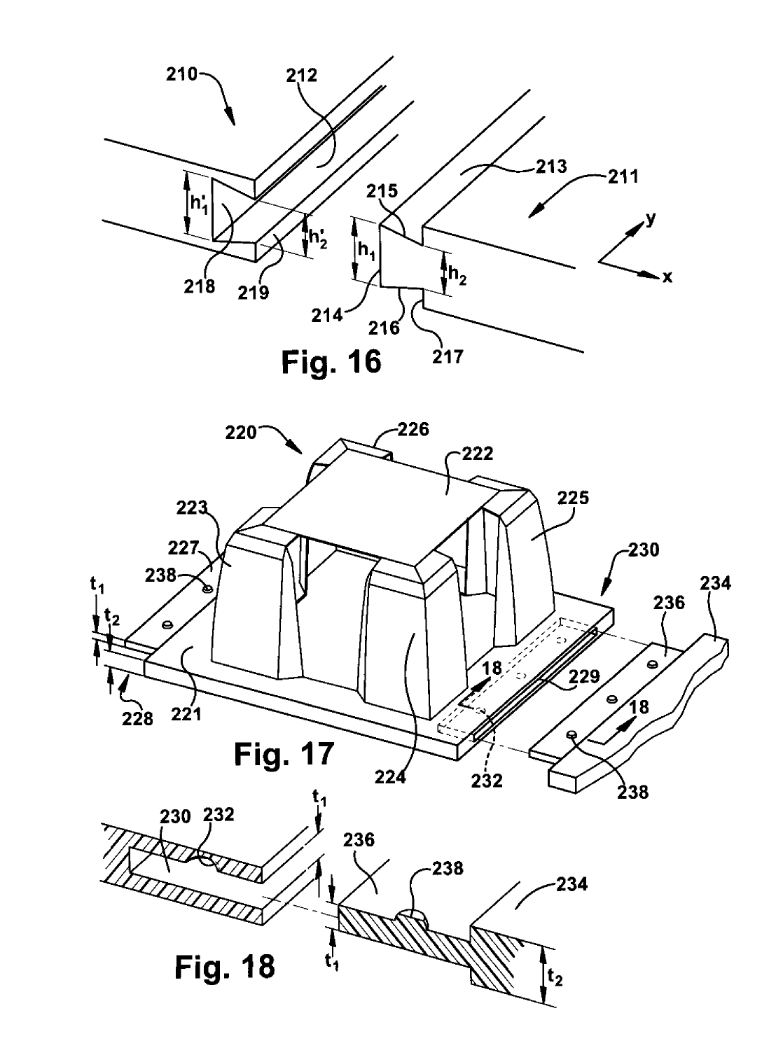

FIG. 16 is a perspective illustration showing base portions 210 and 211 of two energy absorbers and the mating connector members 212 and 213 of a slide dovetail connector. The base portions 213, 212 of two energy absorbers are connected by sliding one energy absorber along the Y-axis relative to the other, to achieve a dovetail connection. As shown by mating connector member 213, which is a male member, has an end wall having a height of h₁ and tapers along surfaces 215 and 216 to a smaller height h₂ of the connector portion. Mating connector portion 212, which is a female connector, has a height of h₂′ along the outer surface of the base and tapers to a larger height of h₁′ along surface 218. The heights h₁′ and h₂′ are slightly larger than the heights h₁ and h₂, respectively to allow for easy sliding of the dovetail connection.

In another embodiment of the invention, FIG. 17 shows an energy absorber 220 having a base 221, a top 222, plurality of legs 223, 224, 225 and 226 and mating connector members 228 and 230 of a slide interlock connectors. Mating connector member 228 that extends from base 221 has a slide 227 and mating connection member 230 has a slot opening 229 along the opposite side of the base 221. FIG. 17 also shows a portion of an adjacent energy absorber that includes mating connector member 234 that is substantially identical to mating connector member 228 of energy absorber 220. Mating connector member 234 also includes a slide 236 similar to slide 227 of energy absorber 220. Slides 227 and 236 have a thickness of t₁ that is less than the thickness t₂ base 221. Slot opening 229 of mating connector member 230 has a height opening which is slightly larger than the thickness ti of slide 236 in order to receive slide 236. In another embodiment, slides 227 and 236 can also include at least one protrusion 238 which is received by 232 which extends into the slot opening 229 of mating connector member 230. FIG. 18 is a cross-sectional view taken along lines 18-18 (FIG. 17) of the mating connector members 230 and 234. The cross-section is taken through protrusion 232 which can be forced into slot opening 230 to interlock with recess 232 of slot opening 229 of energy absorber 220. The recesses such as recess 232 of mating connecting member 230 align with the protrusions, such as protrusion 238 so that the protrusions snap-fits into the recesses to lock the joined energy absorbers.

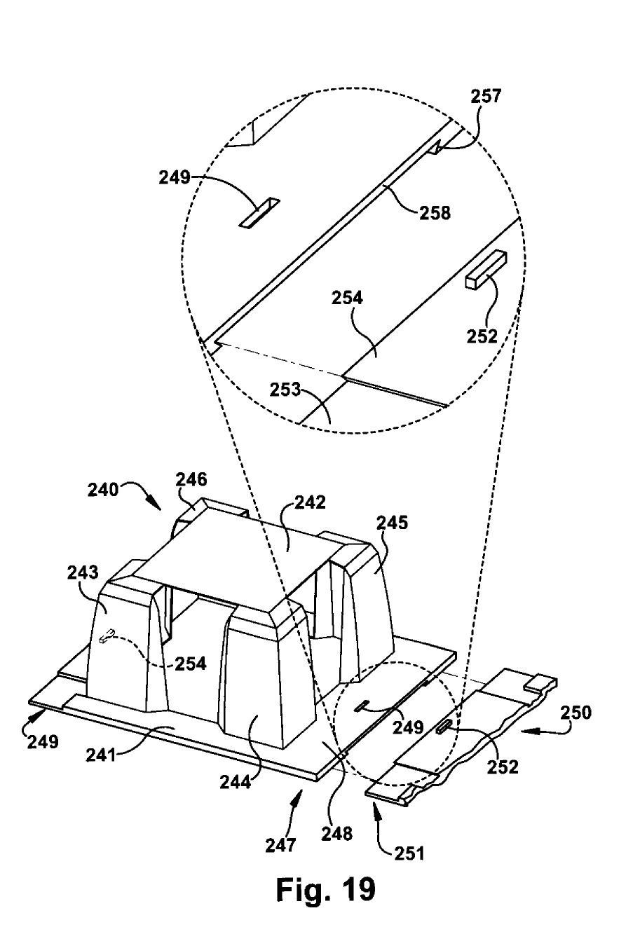

FIG. 19 illustrates energy absorber 240 having base 241, top 242, legs 243, 244, 245 and 246 and mating connector members 247 and 249 of a combination slide and interlock connector. Also shown is a portion of energy absorber 250 and mating connector member 251 combination interlock and slide dovetail connector. The top surface 248 of mating connector member 247 is substantially planar and has an opening 249 therein. Mating connector members 249 and 251 have a locking protrusion 254 (in phantom) and 252, respectively. Locking protrusion 252 is received by opening 249 to lock energy absorber 240 to energy absorber 250. In another embodiment the height of the locking protrusions 252, 254 of mating connector members 251, 249, respectively, are substantially equal to or less than the depth of the slot opening 249 of mating connector member 247. In this arrangement, the locking protrusion does not protrude beyond the top surface 248 of the base 241, and therefore, the surface of base 241 remains substantially smooth and/or planar in an energy absorber system. Therefore, the connection method herein, as well as in any of the embodiments described throughout, do not result in a protrusion or pointed load upon impact.

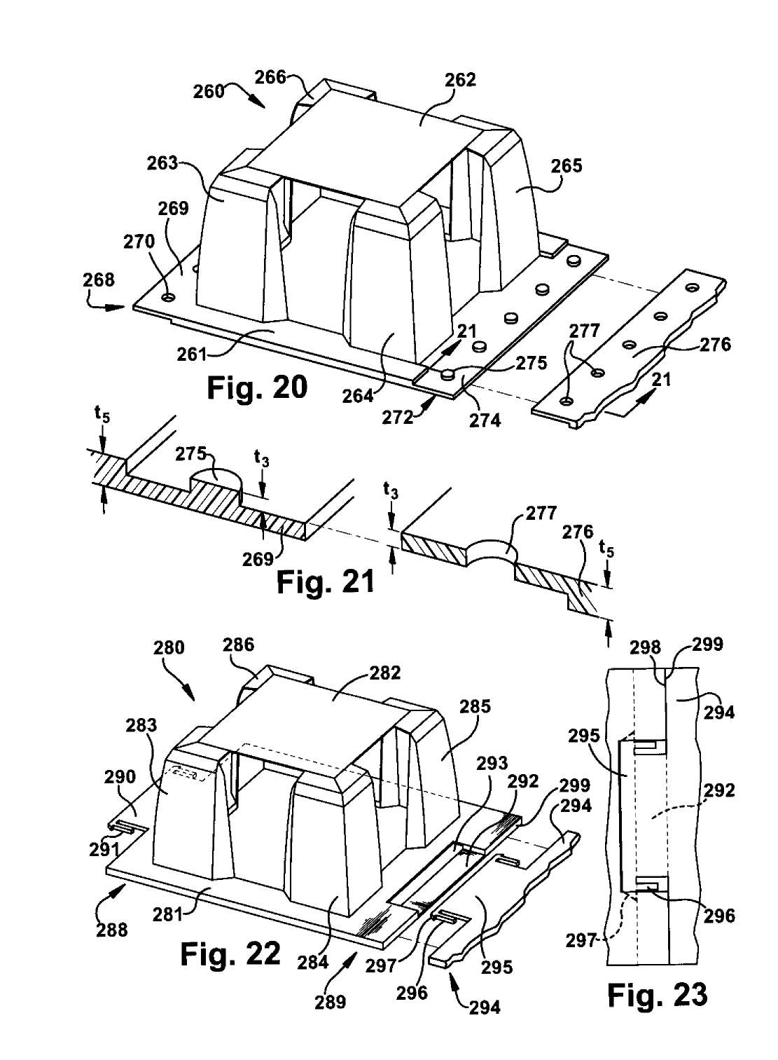

FIG. 20 shows an energy absorber 260 having a base 261, top 262, legs 263, 264, 265, 266 and mating connector members 268 and 272 of an interference fit interlock connector according to another example embodiment. Base 261 includes mating connector portion 272 which has a recessed surface 274 and includes at least one protrusion 275. Mating connector member 276 of a second energy absorber is substantially identical to mating connector member 268 of energy absorber 260. Mating connector members 268 and 276 have openings 270 and 277 receive protrusions, such as protrusion 275. FIG. 21 shows that mating connector members 268 and 276 each have a thickness t₃ which is substantially equal or greater than the thickness t₃ of protrusion 275 of mating connector member 272 so that protrusion 275 does not protrude beyond openings 277 of mating connector member 276. When mating connector members 272 and 276 are joined to form an interference fit interlock connector, the combined thickness of section 270 of mating connector member 272 and thickness t₄ of mating connector member 276 can be substantially equal to thickness t₅ of base 261. The plurality of protrusions 275 provide for a series of rigid cross-fit connections so that the energy absorber 260 may be joined to a second energy absorber. Likewise a third energy absorber (not shown) can be joined to mating connector member 268 on a second side of energy absorber 260. After assembly, the substantially planar bases of the energy absorber system which includes energy absorber 260 is substantially free from any protrusions and/or loads that might otherwise injure an occupant.

Energy absorber 280 of FIG. 22 includes mating connector member 288 and 289 of a snap-fit connector. A portion of a second energy absorber that includes mating connector member 294 is substantially the same as mating connector member 288. Mating connector members 288 and 294 have a main body 290 and 295, respectively, and at least one flex finger, for example flex fingers 291 and 296, respectively, which extend from the main body and are spaced a distance apart from the main body. When the mating connector member 294 (male portion) is inserted into the mating connector member 289 (female portion) of energy absorber 280, the flex fingers 296 depress toward the main body 295 as mating connector member 294 is passed across ledge 292 and inserted into the opening 293 of the mating connector member 289. A top view FIG. 23 of the snap-fit connection shows that once the flex fingers 296 pass into the opening 293 beyond ledge 292, the flex fingers release and a protrusion 297 (shown in phantom) of mating connector member 294 rests along the ledge 292 (shown in phantom) of mating connector member 289 of the energy absorber 280. When the flex fingers rest against the ledge of the female connector portion 284 the energy absorbers are locked together, thus preventing them from being pulled apart.

The various embodiments of energy absorbers having mating connector members and energy absorber systems having various connectors are just a few of several possible connectors contemplated within the scope of the present invention. As described above, any of the various embodiments of energy absorber systems can include at least two mating connector members that when joined together result in a base that is substantially free of protrusions or pointed loads before impact and or upon impact.

The energy absorbers herein can be selected from a variety of polymers having a range of modulus properties and other characteristics such as toughness, ductility, thermal stability, high-energy absorption capacity, and a good modulus to elongation ratio, for example. In addition, an energy absorber system can include a combination of energy absorbers made of different materials. For example, several different polymers may be used for individual energy absorbers that are connected to one another, or alternatively, several of the same materials can be used to form an energy absorber system. Therefore, another aspect in appropriately tuning the energy absorber of the embodiments described above is the selection of the thermoplastic resin to be employed. The resin employed may be a low modulus, medium modulus or high modulus material as needed. By carefully considering each of these variables, energy absorbers meeting the desired energy impact objectives can be manufactured. The characteristics of the material utilized to form the energy absorber include high toughness/ductility, thermally stable, high energy absorption capacity, a good modulus-to-elongation ratio and recyclability, among others.

While the energy absorber may be molded in segments, it is preferably that it be of unitary construction made from a tough plastic material. Materials that are useful for molding the energy absorber include engineering thermoplastic resins. Typical engineering thermoplastic resins include, but are not limited to, acrylonitrile-butadiene-styrene (ABS), polycarbonate, polycarbonate/ABS blend, polyester, such as polybutylene terephthalate (PBT), a copolycarbonate-polyester, acrylic-styrene-acrylonitrile (ASA), acrylonitrile-(ethylene-polypropylene diamine modified)-styrene (AES), phenylene ether resins, blends of polyphenylene ether/polyamide, blends of polycarbonate/PET/PBT, polybutylene terephthalate, polyimides (PEI) polyamides, phenylene sulfide resins, polyvinyl chloride PVC, high impact polystyrene (HIPS), low/high density polyethylene (LDPE, HDPE), polypropylene (PP) and thermoplastic olefins (TPO), and blends thereof.

While embodiments of the invention have been described, it would be understood by those skilled in the art that various changes may be made and equivalence may be substituted for the energy absorber or system thereof without departing from the scope of the invention. For example, although example embodiments discussed above pertain to vehicles, it should be understood that several other applications may find use of the energy absorbing unit and energy absorbing system. In addition, several different energy absorber designs may be used and mating connector members and connectors may be used, as well as different polymers. Therefore, many modifications may be made to adapt the energy absorber and system to the teachings of the invention without departing from the essential scope thereof. Therefore, it is intended that the invention not be limited to particular embodiments, but that the invention will include all embodiments falling within the scope of the pending claims.

We claim:

1. An energy absorber comprising:
a base;
a top spaced a distance from the base;
a plurality of legs each having a length which extends from the top to the base and which are spatially arranged with window openings interposed between the legs.

2. The energy absorber of claim 1, wherein at least one of the plurality of legs joins the top along a first vertical plane and joins the base along a second vertical plane which is different than the first vertical plane.

3. The energy absorber of claim 1, wherein the energy absorber comprises a plurality of sides defined by the top and the base, and each of the plurality of sides comprises at least one leg.

4. The energy absorber of claim 3, wherein each of the plurality of sides comprises one leg.

5. The energy absorber of claim 1, wherein the energy absorber comprises a plurality of sides defined by the top and the base, and each of the plurality of sides comprises a leg segment of a first leg and a leg segment of a second leg.

6. The energy absorber of claim 1, wherein the energy absorber comprises four sides defined by a rectangular top and a rectangular base, and each side comprises one leg.

7. The energy absorber of claim 1, wherein the energy absorber comprises four sides defined by a rectangular top and a rectangular base and each side comprises a leg segment of a first leg and a leg segment of a second leg.

8. The energy absorber of claim 1, wherein the cross-section of the legs varies along its length.

9. The energy absorber of claim 1, wherein a portion of at least one of the plurality of legs comprises a cross-section that is concave.

10. The energy absorber of claim 1, wherein a portion of at least one of the plurality of legs comprises a cross-section that is convex.

11. The energy absorber of claim 1, wherein a portion of at least one of the plurality of legs comprises a cross-section that is substantially planar.

12. The energy absorber of claim 1, wherein each of the plurality of legs comprises a rib.

13. The energy absorber of claim 1, wherein each of the plurality of legs comprises a first leg segment and a second leg segment which are oriented at an angle relative to one another.

14. The energy absorber of claim 1, wherein at least one of the plurality of legs comprises a first leg segment and a second leg segment which are oriented at an angle less than 180 degrees, relative to one another.

15. The energy absorber of claim 14, wherein only a portion of the at least one leg comprises a first leg segment and a second leg segment which are oriented at an angle which ranges from 45 degrees to 135 degrees, relative to one another.

16. The energy absorber of claim 15, wherein a portion of each of the plurality of legs is angled between the base and the top of the energy absorber.

17. The energy absorber of claim 1, wherein the top of the energy absorber has a plurality of sidewalls and each of the legs contacts a sidewall of the top.

18. The energy absorber of claim 1, wherein:
the top is a polygon comprising at least two sidewalls which meet at a corner to form a first angle; and
at least one of the plurality of legs has two leg segments which meet at a corner to form a second angle substantially equal to the first angle; and
the corner of at least one of the legs aligns and interfaces with the corner of the top.

19. The energy absorber of claim 18, wherein:
the base comprises internal sidewalls which define the base opening, the internal sidewalls meet at a corner to form a third angle substantially equal to the second angle between the corner of at least one of the legs; and
the corner of at least one of the legs aligns and interfaces with the corner of the base.

20. The energy absorber of claim 1, wherein the window openings between the plurality of legs extend from the top to the base.

21. The energy absorber of claim 1, wherein the legs are substantially equidistant from one another.

22. The energy absorber of claim 1, wherein the legs are substantially the same height.

23. The energy absorber of claim 1, wherein the bottom comprises an opening.

24. The energy absorber of claim 1, wherein the base comprises an opening and the area of the top is less than the area of the opening formed by the base.

25. The energy absorber of claim 24, wherein at least one of the window openings extends from the top to the base.

26. The energy absorber of claim 1, wherein each of the plurality of legs comprises a radius.

27. The energy absorber of claim 26, wherein the radius directs the leg inward to connect to the top of energy absorber.

28. The energy absorber of claim 26, wherein the radius extends outward to connect to the base of the energy absorber.

29. The energy absorber of claim 1, further comprising at least one mating connector member.

30. The energy absorber of claim 1, further comprising at least two mating connector members.

31. The energy absorber of claim 1, wherein the base comprises at least two mating connector members that are different.

32. The energy absorber of claim 29, wherein:
the base comprises the at least one mating connector member connected to a second mating connector member; and
the base is substantially free of surface protrusions when connected to a second connector member.

33. The energy absorber of claim 29, wherein:
the base comprises the at least one mating connector member connected to a second mating connector member; and
the base is substantially free of surface protrusions upon impact.

34. The energy absorber of claim 29, wherein:
the base comprises the at least one mating connector member connected to a second mating connector member; and
the base is a substantially planar surface.

35. The energy absorber of claim 30, wherein the at least one mating connector member is a mating member of a connector selected from the group of: a flex finger interlock connector, a slide dovetail connector, a slide interlock connector, a combination interlock and slide dovetail connector, an interference fit interlock connector, a snap fit connector and combinations thereof.

36. The energy absorber of claim 1, further comprising at least one mating connector member which is a mating connector member of a flex finger interlock connector.

37. The energy absorber of claim 1, further comprising at least one mating connector member that is a mating connector member of a slide dovetail connector.

38. The energy absorber of claim 1, further comprising at least one mating connector member that is a mating connector member of a slide interlock connector.

39. The energy absorber of claim 1, further comprising at least one mating connector member which is a mating connector member of a combination interlock and slide dovetail connector.

40. The energy absorber of claim 1, further comprising at least one mating connector member that is a mating connector member of an interference fit interlock connector.

41. The energy absorber of claim 1, further comprising at least one mating connector member that is a mating connector member of a snap fit connector.

42. An energy absorber system comprising a first energy absorber of claim 1 which is connected to a second energy absorber.

43. The energy absorber system of claim 42, wherein:
the base of the first energy absorber comprises a first mating connector member;
the second energy absorber comprises a base comprising a second mating connector;
the first mating connector member is joined to the second mating connector member to form a base of the energy absorber system; and
the base of the energy absorber system is substantially free of surface protrusions.

44. The energy absorber system of claim 42, wherein:
the base of the first energy absorber comprises a first mating connector member;
the second energy absorber comprises a base comprising a second mating connector;
the first mating connector member is joined to the second mating connector member to form a base of the energy absorber system; and
the base of the energy absorber is substantially free of surface protrusions upon impact.
